(19) United States
(12) Patent Application Publication
(10) Pub. No.: US 2013/0159105 A1
(43) Pub. Date: Jun. 20, 2013

(54) EXTENDED DURATION ADVERTISING BASED ON INFERRED USER CATEGORIZATION

(71) Applicants: Oleksii Kuchaiev, Bellevue, WA (US); Lingfeng Wu, Bellevue, WA (US); Vu A. Ha, Kirkland, WA (US)

(72) Inventors: Oleksii Kuchaiev, Bellevue, WA (US); Lingfeng Wu, Bellevue, WA (US); Vu A. Ha, Kirkland, WA (US)

(73) Assignee: MICROSOFT CORPORATION, Redmond, WA (US)

(21) Appl. No.: 13/332,352

(22) Filed: Dec. 20, 2011

(51) Int. Cl. G06Q 30/02

(52) U.S. Cl. 705/14.54; 705/14.66; 705/14.1; 705/14.71; 705/14.58

(57) ABSTRACT

Advertisements are provided to users for an extended period of time based on a categorization of those users into one or more audiences. A user is being offered credits in exchange for the display such advertisements, which can be utilized to purchase items of value. The advertisements are selected based on which audience a user belongs to and a user is categorized as a member of one or more audiences based on a user profile that is informed by information explicitly provided by the user, information generated by the user to which the user has granted permission and contextual information, such as location. An audience taxonomy is centrally maintained and provided to enable categorization without transmitting users' information off of their computing devices. Advertisers bid on advertisements, not by bidding on keywords, but rather by bidding on the duration for which advertisements are displayed to selected audiences.

### BACKGROUND

Like traditional advertising, advertising displayed to a user through a computing device attempts to elicit a desired response from the user, such as to cause the user to purchase the advertised product or service. And like traditional advertising, advertising displayed to users through a computing device has a greater chance of eliciting the desired response from the user if the displayed advertising is relevant, or meaningful, to the user. Unlike traditional advertising, however, advertising displayed to users through a computing device can be based on information derived from that user's interactions with that computing device. Thus, while traditional advertising is only generically targeted, such as, for example, by placing advertisements for men's products in automotive-centric publications, advertising displayed to users through a computing device can be targeted much more specifically. For example, within the context of a content browser application program, such as the ubiquitous web browser, a user that has searched for a specific term can be assumed to be interested in products associated with that term, and advertisements for such products can be displayed to such a user as part of the search web page, or other like presentation within the context of the web browser.

Unfortunately, such advertising is often presented for a very limited duration and at a time when the user was already focused on a different purpose. For example, a user utilizing a web browser to search for a specific term is focused on finding responsive search results and proceeding with whatever activity caused the user to search for that term in the first place. Consequently, the user often ignores advertisements that are presented to them within that context. Additionally, because such advertisements were presented within the context of a specific webpage, such as the webpage generated by the search engine in response to the user's query, their presentation to the user is transient, often being displayed to the user for only a few seconds. Thus, even if the user were to be influenced by the advertisement, if the user has already browsed away from that webpage, he may not be able to find such an advertisement again or remember the product or service that it was advertising. Conversely, users have little incentive to allow advertisements to be displayed to them for extended periods of time because, as indicated previously, on many occasions users perceive advertisements as a distraction, or detraction, from their actions.

### SUMMARY

In one embodiment, advertisements can be displayed to a user for an extended period of time, such as over a period of days, by being displayed within the context of a main screen or background, such as can be displayed by a mobile computing device, rather than being limited to being presented within the context of one single application. To entice users to agree to such advertisement presentation, users can be offered credits for allowing such advertisement presentation. Such credits can be utilized, by the users, to obtain items of value to those users such as, for example, computer-executable instructions in the form of application programs that can execute on the mobile computing device, or gift cards to affiliated merchants or retailers. Alternatively, such credits can be utilized to offset or discount items of value to those users such as, for example, computing devices or peripherals thereof.

In another embodiment, advertisements displayed to a user for an extended period of time can be selected based on a determination of which audience a particular user belongs to. A user's audience affiliation can be determined based on a user profile that can be maintained on that user's computing device and can be based on information that the user either specifically provided or agreed to allow access to. Additionally, a user can allow access to contextual information, such as the location of the user and their mobile computing device.

In a further embodiment, advertisers can bid to have their advertisements displayed to users, not based on keywords but rather on an aggregate exposure time to a specific audience. The advertisements that are selected to be displayed to users of a particular audience can be selected in a traditional manner based on the amount of the advertisers' bids.

In a still further embodiment, a taxonomy of audiences can be centrally maintained and can be provided to the users' computing devices to enable determination of which audience a user belongs in without transmitting a user's personal information from their computing device. The taxonomy of audiences can be updated to create or remove audiences in accordance with user behavior an advertiser desires.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Additional features and advantages will be made apparent from the following detailed description that proceeds with reference to the accompanying drawings.

### DESCRIPTION OF THE DRAWINGS

The following detailed description may be best understood when taken in conjunction with the accompanying drawings, of which:

FIG. 1 is a block diagram of an exemplary provision of advertisements for an extended period of time based on a user's categorization into one or more audiences;

FIG. 2 is a flow diagram of an exemplary categorization of a user into one or more audiences for determining which advertisements to receive for an extended period of time; and

FIG. 3 is a block diagram of an exemplary computing device.

### DETAILED DESCRIPTION

The following description relates to the provision of advertisements to users for an extended period of time based on a categorization of those users into one or more audiences. A set of computer-executable instructions can display advertisements within the context of a main screen or background, such as can be displayed on a mobile computing device, where such advertisements can be displayed for an extended period of time, which can typically be longer than one day. A user can be enticed to provide for the execution of such computer-executable instructions by being offered credits in exchange for the display of such advertisements. The credits can then be utilized by the user to purchase or receive items of value including, for example, other computer-executable instructions, in the form of software application programs, which can execute on the mobile computing device, gift cards at selected retailers or merchants, discounts on specific items, and other like items. The advertisements that can be displayed can be selected based on which audience a user belongs to. The categorization of a user as a member of one or more audiences can be based on a user profile that can be informed by information explicitly provided by the user, and information generated by the user which the user has granted permission to be accessed and utilized in such a manner. Additionally, a user profile can include contextual information which, if allowed by the user, can include location information and the like. An audience taxonomy can be centrally maintained and provided to individual computing devices to enable categorization of users into one or more audiences without transmitting the users' information off of their computing devices. The audience taxonomy can be updated based on the actions of users and the desires of advertisers. Advertisers can bid on advertisements, not by bidding on keywords, but rather by bidding on the length of time for which advertisements are to be displayed to selected audiences.

For purposes of illustration, the techniques described herein make reference to existing and known networking infrastructure, such as the ubiquitous Internet and World Wide Web (WWW). Such references, however, are strictly exemplary and are not intended to limit the mechanisms described to the specific examples provided. Indeed, the techniques described are applicable to any environment within which advertisements can be presented to users for an extended period of time.

Although not required, the description below will be in the general context of computer-executable instructions, such as program modules, being executed by a computing device. More specifically, the description will reference acts and symbolic representations of operations that are performed by one or more computing devices or peripherals, unless indicated otherwise. As such, it will be understood that such acts and operations, which are at times referred to as being computer-executed, include the manipulation by a processing unit of electrical signals representing data in a structured form. This manipulation transforms the data or maintains it at locations in memory, which reconfigures or otherwise alters the operation of the computing device or peripherals in a manner well understood by those skilled in the art. The data structures where data is maintained are physical locations that have particular properties defined by the format of the data.

Generally, program modules include routines, programs, objects, components, data structures, and the like that perform particular tasks or implement particular abstract data types. Moreover, those skilled in the art will appreciate that the computing devices need not be limited to conventional personal computers, and include other computing configurations, including hand-held devices, multi-processor systems, microprocessor based or programmable consumer electronics, network PCs, minicomputers, mainframe computers, and the like. Similarly, the computing devices need not be limited to stand-alone computing devices, as the mechanisms may also be practiced in distributed computing environments where tasks are performed by remote processing devices that are linked through a communications network. In a distributed computing environment, program modules may be located in both local and remote memory storage devices.

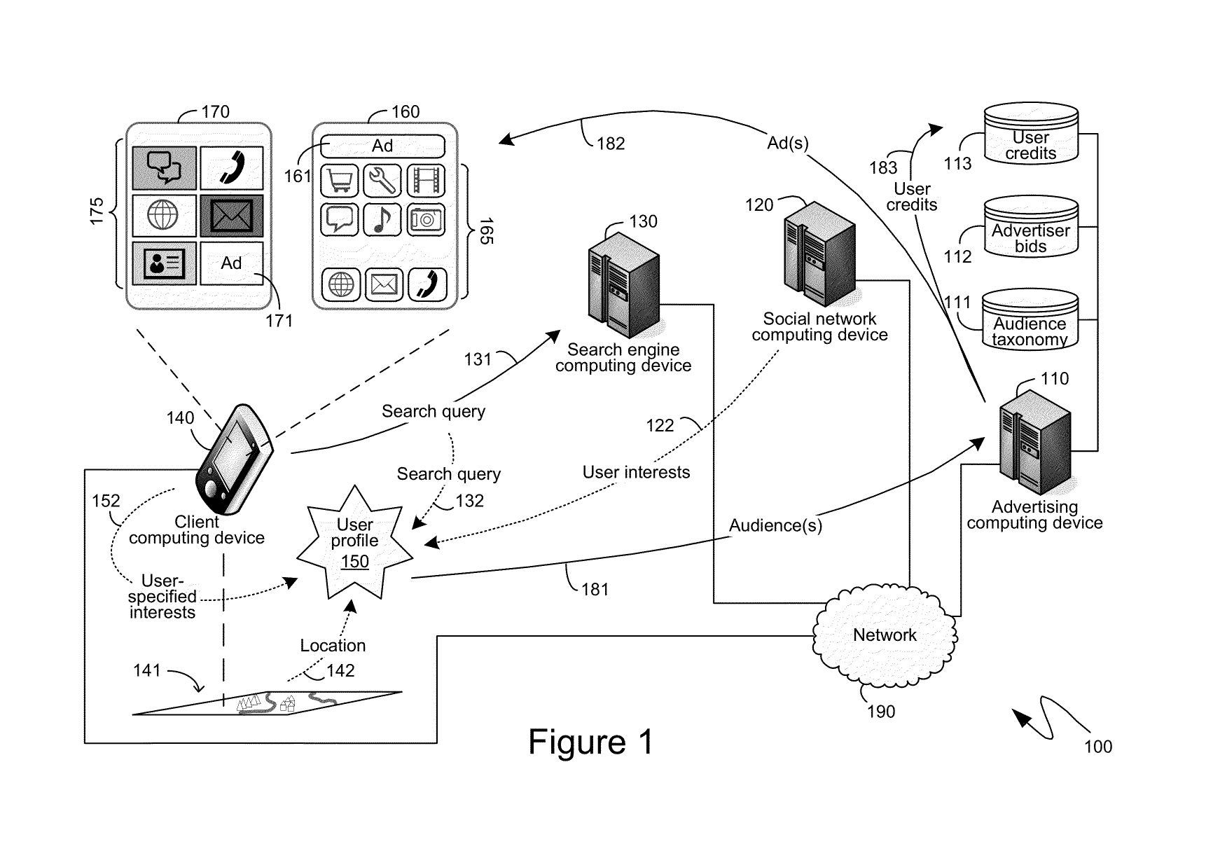

Turning to FIG. 1, an exemplary system 100 is shown, comprising an advertising computing device 110, a social network computing device 120, a search engine computing device 130 and a client computing device 140 in the form of a mobile personal computing device such as, for example, a smart phone, a tablet computing device, or other like mobile computing device. The various computing devices illustrated in the exemplary system 100 of FIG. 1 can be communicationally coupled to one another, as well as to other computing devices, via a network such as the exemplary network 190 that is shown in FIG. 1. As will be recognized by one of skill in the art, while the descriptions below have been provided within the context of a mobile computing device, they are equally applicable to any type of client computing device, including laptop computing devices and desktop computing devices. In one embodiment, computer-executable instructions executing on the client computing device 140 can generate a user profile 150 that can be utilized to categorize the user of the client computing device 140 into one or more audiences for which advertising can be sold. The user profile 150 can be constructed based on user-specified interests, information obtained by observing user's actions on the client computing device 140, to the extent explicitly allowed by such user, and contextual information such as the current location of the client computing device 140.

In one embodiment, the computer-executable instructions executing on the client computing device 140 can prompt the user of that computing device to explicitly specify one or more interests or items of interest. For example, the user can identify themselves as being interested in various types of products such as, for example, cars, computing devices, wristwatches, kitchen appliances, handbags, shoes, and other types of products. As another example, the user can identify themselves as being interested in various activities such as, for example, movie watching, hiking, camping, shopping, home repair, and other types of activities. Typically, to enable the user to explicitly specify such interests, a wide-ranging listing of preferences and interests can be presented to a user, such as via the display of the client computing device 140, and the user can be instructed to select one or more preferences or interests that are relevant to that user. Alternatively, or in addition, the user can also explicitly specify their preferences by entering them directly, such as through a text box, image detection mechanism, voice recognition and the like. In such a case, to the extent that the user's entries are not understood, such as by a context engine, which will be described in further detail below, reference can be made to other data stores, such as those available via the network 190. Within the exemplary system 100 of FIG. 1, the generation of the user profile 150 via such user-specified interests is represented by the dashed arrow 152.

To enable a user of the client computing device 140 to more efficiently specify their preferences and interests, the user can be allowed to reference an existing set of information that can already comprise such a specification of preferences and interests. For example, the user of the computing device 140 can be allowed to reference, or “link to”, one or more profiles of such a user that the user may have previously established such as, for example, via social networking paradigms with which the user may have previously interoperated. As another example, the user could be allowed to reference a collection of email that can indicate that user's shopping or researching habits, or the user could be allowed to reference one or more credit card statements to enable identification of the types of items the user purchased and the retailers and service provides at which the user shops. In such a case, the computer-executable instructions executing on the client computing device 140 can utilize the information provided by the user to access, such as via the network 190, one or more referenced collections of information, such as the user's email, their credit card statements or their social network profiles. For purposes of illustrating such referencing, social network computing devices, such as the social network computing device 120, are shown in the exemplary system 100 of FIG. 1. The user interests that a user can have already established as part of one or more social networking profiles, or other like data sources that can indicate user interests, can also be utilized to construct the user profile 150, as illustrated by the dashed arrow 122 shown in FIG. 1.

In one embodiment, in addition to requesting that a user explicitly enumerate their interests, or provide a link to already explicitly enumerate interests, such as via a social networking profile, the computer-executable instructions executing on a client computing device, such as the client computing device 140, can also request the user allow that such computer-executable instructions collect information from specific actions that the user may undertake on the client computing device 140. For example, the computer-executable instructions may request that the user grant them access to the user's search history, which can include searches performed by the user utilizing a dedicated searching application that can execute on the client computing device 140, and can also include searches performed by the user utilizing a generic browsing application, such as a web browser, that can also execute on the client computing device 140. As another example, the computer-executable instructions can request that the user grant them access to the user's past actions within the context of specific types of application programs that can execute on the client computing device 140, such as, for example, purchasing application programs that enable the user to purchase items from the client computing device 140, instant messaging application programs, networked forum posting application programs, and other like specific types of application programs.

If the user grants access to such requested information, then prior user actions, or user “history”, as well as subsequent user actions can also be utilized to generate the user profile 150. As indicated previously, such information can only be utilized if the user explicitly grants permission, such that the user retains control over their personal information and how it is utilized. Additionally, as will be described in detail below, the precise information about the user that is collected need not be specifically maintained as such. Instead, it is only relevant to the extent that it informs the categorization of the user into one or more audiences for purposes of determining which advertisements are to be displayed to the user.

For example, if the user of the client computing device 140 granted access to their search history, then the computer-executable instructions executing on the client computing device 140 could utilize such a search history to construct the user profile 150. Thus, as shown in the exemplary system 100 of FIG. 1, to the extent that the user directs a search query 131 to a search engine computing device such as, for example, the search engine computing device 130, that search query can be utilized to inform the user profile 150, as illustrated in the dashed arrow 132. Similarly, to the extent that the user of the client computing device 140 granted access to other sources of information generated by the user, those other sources could, likewise, be utilized to generate the user profile 150.

In one embodiment, the user profile 150 can be utilized to categorize user of the client computing device 140 into one or more audiences. An advertising computing device, such as the advertising computing device 110, can maintain an audience taxonomy 111 that can define various audiences or categories of users to which advertisers can direct advertisements. For example, the audience taxonomy 111 can include audiences of users that are interested in cars, kitchen appliances, computing devices, handbags, hiking, shopping, home repair, and a wide range of other interests. The audience taxonomy 111 can be provided, such as by the advertising computing device 110, to the computer-executable instructions executing on the client computing device 140 to enable those computer-executable instructions to categorize user of the client computing device 140 into one or more of the audiences based on the user profile 150.

In categorizing the user of the client computing device 140 into one or more audiences based on their user profile 150, an inference engine can be utilized to identify, for example, that searches for a specific model number indicate that the user should be categorized as part of the audience of users who are interested in kitchen appliances because the specific model number for which a user was searching is a model number of, for example, a blender. Similarly, such an inference engine could identify that a user should be categorized as part of the users who enjoy hiking because the user has been searching for backpacks, water bottles, wool sweaters, and other like items that, individually, may not necessarily identify the user as a hiking enthusiast, but, in aggregate, can be more indicative of the user's interests.

Because user interests can change over time, more recent indicia of a user's interest can carry greater weight then older indicia. For example, if the user initially indicated that they are a car enthusiast, but has not generated any automotive related search queries, nor has visited any automotive centric webpages, then even though the user may have explicitly indicated that they are a car enthusiast, the user profile 150 can comprise more recent information that can suggest otherwise, and the user need not be categorized into the car enthusiast audience. Similarly, a user may be interested in a specific item only for a defined period of time. For example, a user may generate many search queries directed to dishwashers when the user's dishwasher has failed and the user is searching to purchase a new dishwasher. Upon purchasing such a dishwasher, however, the user may cease generating search queries directed to dishwashers, since the user is no longer shopping for a dishwasher and does not have an intrinsic interest in dishwashers. In such a case, as the user's search queries directed to dishwashers become older, the user profile 150 can change such that the user, who could have been categorized as part of the audience of individuals interested in dishwashers, is no longer categorized as part of that audience. In such a manner the user's audience categorizations can dynamically change over time to maintain parity with the user's interests.

In one embodiment, the user profile 150, and the utilization thereof to categorize the user into one or more audiences, can be informed by the physical location 141 of the client computing device 140, or other like contextual information. As before, prior to accessing such contextual information, the user can be requested to explicitly authorize such access, thereby protecting the user's personal information and preventing its utilization without the user's explicit consent. If, however, the user has authorized the computer-executable instructions executing on the client computing device 140 to access such contextual information, then such contextual information can be utilized in the generation of the user profile 150 and in the categorization of the user of the client computing device 140, based on their user profile 150, into one or more audiences. For example, the audience taxonomy 111 can comprise separate audiences for, for example, shopping enthusiasts in one metropolitan region versus shopping enthusiasts in another, different metropolitan region. Consequently, the location 141 of the client computing device 140 can determine which of those two audiences the user of the client computing device 140 should be appropriately categorized into, assuming that the user profile 150 already indicates that the user of the client computing device 140 is a shopping enthusiast. Within the exemplary system 100 of FIG. 1, the utilization of contextual information, such as the location of client computing device 140, in generating the user profile 150, is illustrated by the dashed arrow 142.

Once computer-executable instructions executing on the client computing device 140 have utilized the user profile 150 and the audience taxonomy 111, which can have been provided by an advertising computing device, such as the advertising computing device 110, to categorize the user of the client computing device 140 into one or more audiences, an advertising computing device, such as the advertising computing device 110, can be informed of such a categorization. For example, as illustrated by the communication 181 in the exemplary system 100 of FIG. 1, computer-executable instructions executing on the client computing device 140 can identify, to the advertising computing device 110, the one or more audiences into which the user of the client computing device 140 has been categorized.

With such audience information, an advertising computing device, such as the advertising computing device 110, can determine, based on the audience information and advertiser bids 112, which can be received from advertisers, which advertisements to provide to specific users. The selected advertisements can then be communicated back to individual client computing devices such as, for example, the client computing device 140, as illustrated by the communication 182 in the exemplary system 100 of FIG. 1. The advertisements provided, by the communication 182, from the advertising computing device 110 to the client computing device 140 can comprise advertisements that can be displayed within defined display areas on the client computing device 140.

In one embodiment, as indicated previously, advertisements can be displayed to users for an extended period of time. Consequently, in such an embodiment, the advertisements are not displayed within the context of a single, specific application, but rather are displayed as part of the general user interface of the client computing device 140, or a user interface that is often presented to a user, such as a “start screen”, or a “lock screen” that can be presented each time the client computing device is accessed. As one example, if the client computing device 140 is a mobile computing device such as, for example, a smart phone or a tablet computing device, it can utilize a simplified user interface, such as the exemplary user interfaces 170 and 160 that are illustrated in the exemplary system 100 of FIG. 1. The exemplary user interface 170 can utilize a “tile” motif, where, as will be recognized by those skilled in the art, each one of the tiles 175 can present information to the user of the client computing device 140 and can, typically, enable the user of the client computing device 140 to access a defined set of computer-executable instructions such as, for example, one or more application programs, that can execute on the client computing device 140. Thus, individual ones of the tiles 175 can provide access to, for example, instant messaging functionality, telephone functionality, content browsing functionality, e-mail functionality, and other like functions that can be provided by computer-executable instructions executing on the client computing device 140. As another example, the exemplary user interface 160 can utilize an “icon” motif, where, as will be recognized by those skilled in the art, each one of the icons 165 can enable the user of the client computing device 140 to access a defined set of computer-executable instructions such as, for example, one or more application programs, that can execute on the client computing device 140. Thus, in a similar manner to that of the tiles 175, individual ones of the icons 165 can provide access to, for example, instant messaging functionality, telephone functionality, content browsing functionality, e-mail functionality, and other like functions that can be provided by computer-executable instructions executing on the client computing device 140.

Within the exemplary user interface 170, utilizing a tile motif, an advertisement 171 can be presented as one of the titles such that, for example, each time a user of the client computing device 140 accesses such a computing device, they can see the advertisement 171. Similarly, within the exemplary user interface 160, utilizing an icon motif, an advertisement 161 can be presented within an area together with the icons 165 such that, for example, each time a user of the client computing device 140 accesses such a computing device, they can see the advertisement 161. In such a manner, the advertisements 171 and 161 can be presented to a user for an extended period of time, such as over a period of days, or even weeks. In one embodiment, the advertisements that can be presented as the advertisements 171 and 161 can be “teaser” advertisements that can seek to entice the user to select those advertisements and be taken to a further advertisement that can provide additional detail. For example, a teaser advertisement need only provide enough information to entice a user to desire to receive more information and need not actually sell the user on the particular product or service that is being advertised. Instead, such a function can be performed by a further advertisement. Consequently, in such an embodiment, the advertisements 171 and 161 can represent areas of the exemplary user interfaces 170 and 160, respectively, that can be interactive in the same manner as the tiles 175 and the icons 165, respectively. For example, if the tiles 175 and the icons 165 are interactive, in the sense that a user selection directed to one of the tiles 175 or one of the icons 165 results in the invocation of, and execution of, a set of computer-executable instructions in the form of an application program, then an analogous set of computer-executable instructions can be executed when the advertisements 171 and 161 are similarly selected, where that analogous set of computer-executable instructions, executing on the client computing device 140, presents the further advertisement which was teased by the teaser advertisement 171 and 161.

While the above descriptions have been provided within the context of exemplary user interfaces that are typically found on mobile computing devices such as, for example, smart phones and tablet computing devices, the mechanisms described herein are equally applicable to user interfaces presented by other types of computing devices, including laptop and desktop computing devices. For example, modern computing device operating systems typically comprise a “dock”, “taskbar”, or other like user interface element that remains visible irrespective of the specific applications or other collections of computer-executable instructions that a user may currently be executing. Consequently, as another example, advertisements, such as the advertisements 171 and 161, can be presented within the context of such docks, taskbars, backgrounds and other like user interface elements.

In one embodiment, to entice a user, such as the user of the client computing device 140, to execute computer-executable instructions to perform the above described actions and display advertisements, such as the advertisements 171 and 161, a user can be provided with credits as compensation for displaying the advertisements 171 and 161. In one embodiment, when a user initially executes an application program, such as can comprise the computer-executable instructions for performing the above described actions and displaying advertisements, such as the advertisements 171 and 161, that application program can notify an advertising computing device, such as the advertising computing device 110, of its activation. Thereafter, for each advertisement sent to the client computing device 140 upon which such an application program is executing, such as the advertisements transmitted via the communication 182, and for each unit of time that such an application remains active on the client computing device 140, the advertising computing device 110 can deposit additional user credits into a user's account, such as to be maintained in the user credit store 113. In one embodiment, the user can be provided with credits while such an application remains active and, when the application is terminated, an explicit termination notice can be transmitted, which can cease the payments of the credits. In an alternative embodiment, the application can transmit periodic “heartbeat” notifications to indicate that it is still active and displaying advertisements to the user, such that, when such period transmissions cease, the application can be considered to have been terminated, and the payment of credits can, likewise cease. The payment of credits, such as by the advertising computing device 110, is illustrated by the communication 183 in the exemplary system 100 of FIG. 1.

Such credits can then be utilized by the user of the client computing device 140 to purchase items of value to such a user, or they can be utilized to provide value to the user, such as by providing discounts on specific items or categories of items. For example, such credits can be utilized by the user to purchase other computer-executable instructions, in the form of application programs that can also execute on the client computing device 140. Alternatively, such credits can be exchanged for monetary instruments, such as gift cards, or the like, which can be utilized at other retailers and merchants. As yet another example, the credits can be utilized to provide discounts, including flat rate discounts, percentage discounts, and “dollar off” discounts to products or services that may be of interest to the user, including, for example, products or services offered by the advertisers providing the advertisements. In one embodiment, the amount of credits that the user receives can be dependent upon the advertisements that have been provided to such a user, such as by being displayed as the advertisements 171 and 161, and can be dependent upon the length of time that such advertisements have been provided to the user. In another embodiment, to discourage users from attempting to “game” the system by artificially changing their interests to cause advertisements that provide more user credits to be displayed on their computing devices, each user can be awarded an equal number of credits irrespective of the specific advertisement that is displayed.

Should the user no longer desire to receive advertisements, such as the advertisements 171 and 161, the user can stop the execution of the above-described computer-executable instructions. In such an event, the user can cease to be part of the one or more audiences into which the user was categorized, and can, consequently, no longer receive advertisements. Additionally, the user would no longer be eligible to receive user credits. Should the user then, subsequently, re-instantiate the above-described computer-executable instructions, the user could rejoin the audiences of which the user was previously a part, or could be categorized into other, new audiences, and can recommence receiving advertisements and earning credits.

By dividing users into audiences according to their interests and, optionally, contexts, and by displaying advertisements for an extended period of time, such that the user is repeatedly and consistently exposed to them over that period of time, the exemplary advertising system illustrated by the exemplary system 100 of FIG. 1 can enable advertisers to place advertisements, not based on an association between the advertiser's advertisements and certain key words or terms that may be associated with the user, such as, for example, terms for which the user has searched on a search engine webpage, but rather, instead, advertisers can select specific audiences, or categories of users, to which their advertisements are to be displayed, and can select a length of time for which they wish to have such advertisements displayed to such users. Thus, in one embodiment, advertisers utilizing the exemplary system 100 of FIG. 1 do not bid on keywords, such as is traditionally done for digital advertising presented over a network, but rather they bid on exposure time to specified audiences. For example, a manufacturer of tents can bid on two days of exposure to 5,000 hiking enthusiasts. As another example, an upscale department store in a specific metropolitan region can bid on one day of exposure to 10,000 purse enthusiasts within the same metropolitan region as the department store, since, as indicated previously, the audience taxonomy 111 can include audiences divided by location, or other like contextual information.

Although bids, by advertisers, can be based on a different set of criteria, namely a selection of an audience and a duration of presentation, as opposed to the traditionally used keyword bidding, advertiser bids can still be maintained, such as in an advertiser bids store 112, in a manner analogously to that traditionally used. Subsequently, when selecting which advertisements to display to specific users, such as the user of the client computing device 140, an advertising computing device, such as the exemplary advertising computing device 110, can select such advertisements based on the audience to which the user belongs, as well as the quantity, for such an audience, of the bids offered by different advertisers. Such a bid evaluation can, likewise, be performed in a traditional manner.

In one embodiment, the audience taxonomy 111 can be dynamically updated, such as by the advertising computing device 110, either in response to user behavior, or in response to advertiser requests, or combinations thereof. For example, through data collected to generate the user profile 170, a determination can be made that a user is not just searching for any sort of car but rather is particularly searching for a specific brand, or automotive manufacturer. Similarly, automotive manufacturers may desire to advertise, not merely to car enthusiasts, but rather individuals who have expressed an interest in that particular automotive manufacturer. In such a case, the audience taxonomy 111 can be updated to include not only an audience of car enthusiasts, but also “sub-audiences” of enthusiasts of specific automotive manufacturers or marques. Although not specifically illustrated by the exemplary system 100 of FIG. 1, were the audience taxonomy 111 to be updated, such an update can be communicated, such as by the advertising computing device 110, to individual client computing devices, such as the client computing device 140. Subsequently, in generating, or updating, the user profile 170 the new audience taxonomy 111 can be taken into account in categorizing the user as a member of one or more of the audiences enumerated in the audience taxonomy 111.

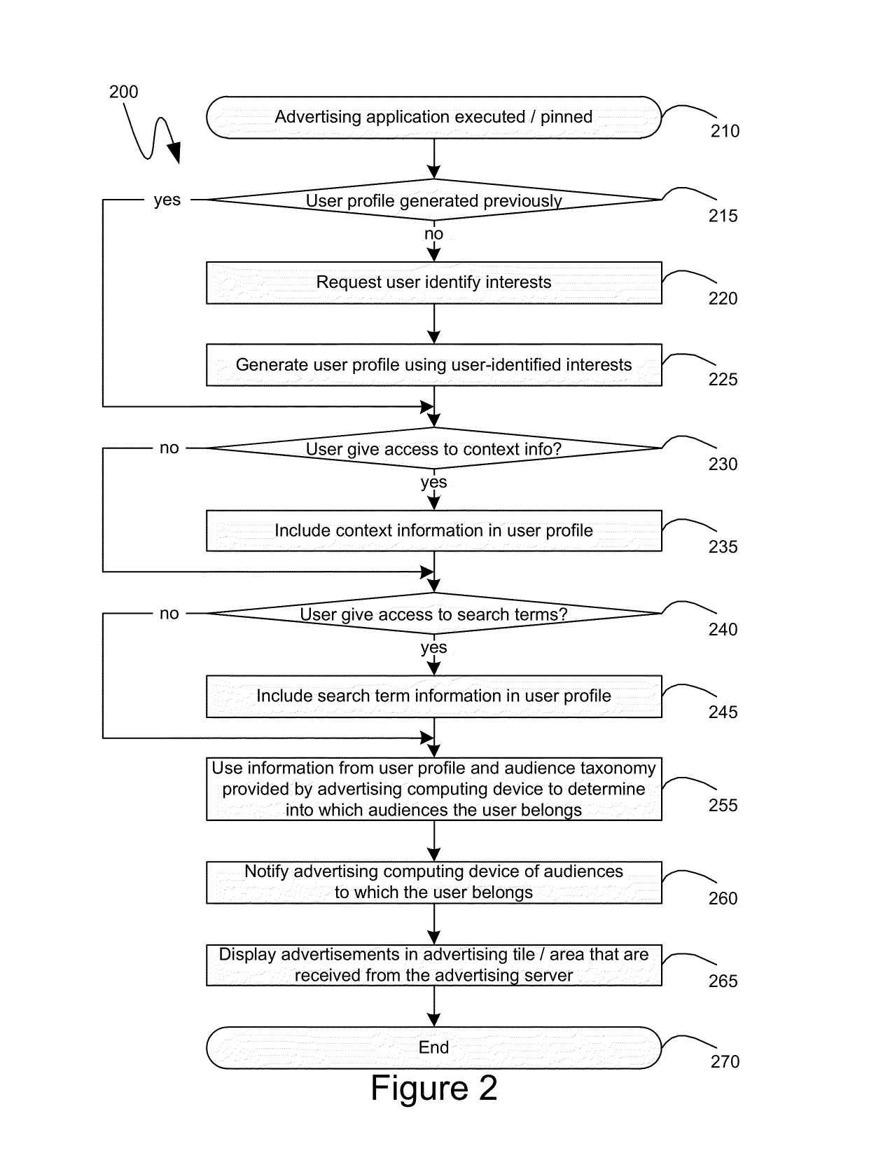

Turning to FIG. 2, the exemplary flow diagram 200 shown therein illustrates an exemplary series of steps that can be performed by computer-executable instructions executing on a client computing device. Initially, as illustrated by step 210, an advertising application can be executed, pinned as a tile, or otherwise instantiated and allowed to execute. Subsequently, at step 215, a determination can be made whether a user profile was previously generated, such as during a prior execution of the advertising application. If such a user profile was generated previously, as determined at step 215, then processing can skip steps 220 and 225 and proceed with step 230, as will be described in further detail below. Conversely, if, at step 215, it is determined that no user profile was previously generated, then, at step 220, in one embodiment the user can be offered the opportunity to explicitly identify their interests, such as by, for example, presenting a list of interests to the user in enabling the user to select one or more of them, or by enabling the user to enter their interests, such as through a text entry mechanism or other like data entry mechanisms. Additionally, as part of step 220, to aid the user in explicitly identifying their interests, the user can be allowed to identify one or more existing profiles or other collections of data from which the user interests can be derived, such as, for example, emails comprising receipts from prior purchases, credit card statements, or, in a social networking context, information from social networking user profiles. Subsequently, at step 225, a user profile can be generated using the identified interests.

At step 230, a request can be made to the user to grant access to contextual information such as, for example, the location of the computing device on which the computer-executable instructions performing the steps of exemplary flow diagram 200 of FIG. 2 are executing. As will be recognized by those skilled in the art, such contextual information can be obtained from sensors that are part of the computing device such as, for example, a positioning sensor or the like. If, at step 230, the user has allowed access to such contextual information, then processing can proceed to step 235 where such contextual information can be included as part of the user profile. For example, if the location of the computing device can be determined, the user profile can be updated to indicate that the user is physically within a defined geographic region, such as a major metropolitan area. If, conversely, at step 230, the user does not grant access to such contextual information, then processing can skip to step 240.

At step 240, a request can be made to the user to grant access to user-generated information from which the users interests can be derived. For example, at step 240, a request can be made to the user to grant access to the search terms that a user enters into a dedicated search application, or into a generic browser, such as a web browser, as part of the user's utilization of a search engine. If, at step 240, the user allows access to such user-generated information, then such user generated information can be collected and can be included as part of the user profile at step 245. As indicated previously, in collecting user-generated information, more recently generated information can be assigned a greater weight, as it can be more probative to the user's current interests. Conversely, if, at step 240, the user did not grant access to user-generated information, then processing can proceed to step 255. At step 255, the user profile can be utilized to identify audiences, from an audience taxonomy that was received from an advertising computing device, in which the user is to be categorized. As indicated previously, by performing such an action on the client computing device, none of the information about the user that is revealed by the user profile is transmitted to any other computing device, thereby protecting the user's privacy. Additionally, as also indicated previously, much of the information utilized, for example, step 245, is not itself retained, but rather is only utilized to inform user profile and, subsequently, identify which audience, from among the audience taxonomy, the user is to be categorized into. For example, the fact that the user was searching for a particular automotive marque during work hours is not retained, only the derived information is retained that, by searching for that automotive marque, the user is found to be an enthusiast of that automotive marque and is categorized into such an audience.

Once one or more audiences in which the user can be categorized are identified at step 255, processing can proceed with step 260, and, at step 260, an advertising computing device can be notified of the identified audiences. In response, as indicated previously, the advertising computing device can then provide advertisements based on the audiences of which the user is a part. More specifically, an advertising computing device can direct specific advertisements to specific audiences, based on advertiser bidding for such audiences, and the user can receive such advertisements, to the extent that the user is part of such audiences. The advertisements from the advertisement computing device can be received at step 265 and can be displayed in a manner such that the user can be exposed to such advertisements repeatedly over an extended period of time. For example, as illustrated in the exemplary system 100 of FIG. 1, such advertisements can be presented within the context of a tile that can be pinned to a start screen, or they can be presented within the context of an area that can be displayed together with icons of other application programs on the client computing device. The relevant processing can then end at step 270.

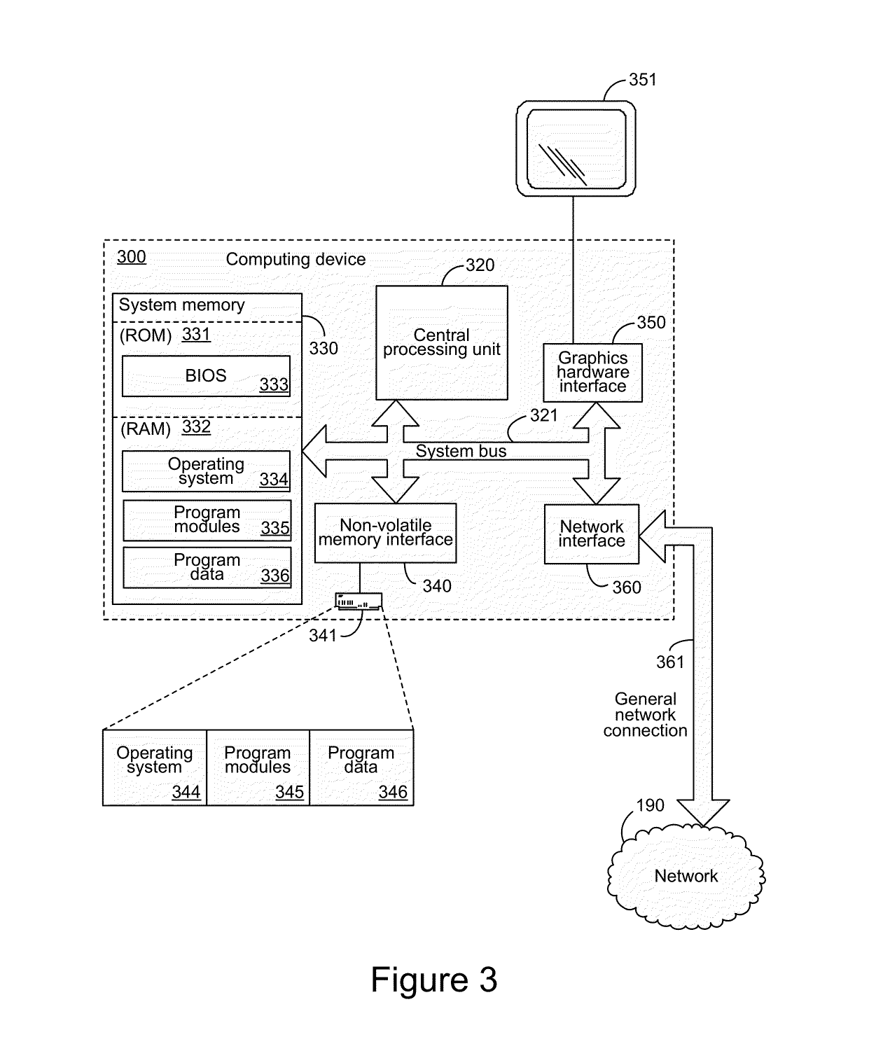

Turning to FIG. 3, an exemplary computing device 300 for implementing the above-described mechanisms is illustrated. The exemplary computing device 300 can be any one or more of the computing devices referenced above, such as those illustrated in FIG. 1, including, for example, the computing devices 110, 120, 130 and 140, whose operation was described in detail above. The exemplary computing device 300 of FIG. 3 can include, but is not limited to, one or more central processing units (CPUs) 320, a system memory 330, that can include RAM 332, and a system bus 321 that couples various system components including the system memory to the processing unit 320. The system bus 321 may be any of several types of bus structures including a memory bus or memory controller, a peripheral bus, and a local bus using any of a variety of bus architectures. The computing device 300 can optionally include graphics hardware, such as for the display of obscured content in the situations described in detail above. The graphics hardware can include, but is not limited to, a graphics hardware interface 350 and a display device 351. Depending on the specific physical implementation, one or more of the CPUs 320, the system memory 330 and other components of the computing device 300 can be physically co-located, such as on a single chip. In such a case, some or all of the system bus 321 can be nothing more than silicon pathways within a single chip structure and its illustration in FIG. 3 can be nothing more than notational convenience for the purpose of illustration.

The computing device 300 also typically includes computer readable media, which can include any available media that can be accessed by computing device 300 and includes both volatile and nonvolatile media and removable and non-removable media. By way of example, and not limitation, computer readable media may comprise computer storage media and communication media. Computer storage media includes media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing device 300. Communication media typically embodies computer readable instructions, data structures, program modules or other data in a modulated data signal such as a carrier wave or other transport mechanism and includes any information delivery media. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 330 includes computer storage media in the form of volatile and/or nonvolatile memory such as read only memory (ROM) 331 and the aforementioned RAM 332. A basic input/output system 333 (BIOS), containing the basic routines that help to transfer information between elements within computing device 300, such as during start-up, is typically stored in ROM 331. RAM 332 typically contains data and/or program modules that are immediately accessible to and/or presently being operated on by processing unit 320. By way of example, and not limitation, FIG. 3 illustrates the operating system 334 along with other program modules 335, and program data 336, which can include the above referenced network browser.

The computing device 300 may also include other removable/non-removable, volatile/nonvolatile computer storage media. By way of example only, FIG. 3 illustrates the hard disk drive 341 that reads from or writes to non-removable, non-volatile media. Other removable/non-removable, volatile/non-volatile computer storage media that can be used with the exemplary computing device include, but are not limited to, magnetic tape cassettes, flash memory cards, digital versatile disks, digital video tape, solid state RAM, solid state ROM, and the like. The hard disk drive 341 is typically connected to the system bus 321 through a non-removable memory interface such as interface 340.

The drives and their associated computer storage media discussed above and illustrated in FIG. 3, provide storage of computer readable instructions, data structures, program modules and other data for the computing device 300. In FIG. 3, for example, hard disk drive 341 is illustrated as storing operating system 344, other program modules 345, and program data 346. Note that these components can either be the same as or different from operating system 334, other program modules 335 and program data 336. Operating system 344, other program modules 345 and program data 346 are given different numbers hereto illustrate that, at a minimum, they are different copies.

The computing device 300 can operate in a networked environment using logical connections to one or more remote computers. The computing device 300 is illustrated as being connected to a general network connection 361 through a network interface or adapter 360 which is, in turn, connected to the system bus 321. In a networked environment, program modules depicted relative to the computing device 300, or portions or peripherals thereof, may be stored in the memory of one or more other computing devices that are communicatively coupled to the computing device 300 through the general network connection 361. It will be appreciated that the network connections shown are exemplary and other means of establishing a communications link between computing devices may be used.

As can be seen from the above description, mechanisms for providing advertisements to users for an extended period of time based on a categorization of those users into one or more audiences have been presented. In view of the many possible variations of the subject matter described herein, we claim as our invention all such embodiments as may come within the scope of the following claims and equivalents thereto.

We claim:

1. One or more computer-readable media comprising computer-executable instructions for presenting advertisements to users for an extended period of time, the computer-executable instructions performing steps comprising:
requesting user permission to access user-generated data indicative of user interests;
generating a user profile utilizing the user-generated data;
categorizing, based on the generated user profile, a user into one or more audiences selected from a received audience taxonomy;
transmitting an identification of the one or more audiences into which the user was categorized;
receiving one or more advertisements based on the transmitted identification of the one or more audiences into which the user was categorized;
generating, on a display device of a computing device executing the computer-executable instructions, a display of the received advertisements in an advertising display area that is repeatedly exposed to the user while the user utilizes the computing device; and
transmitting a termination notification indicating that the received advertisements are no longer being presented in the advertising display area.

2. The computer-readable media of claim 1, comprising further computer-executable instructions for requesting user permission to access a context of the computing device, the context comprising a location of the computing device; wherein the computer-executable instructions for generating the user profile comprise computer-executable instructions for generating the user profile utilizing the context of the computing device.

3. The computer-readable media of claim 1, wherein the user-generated data is user-entered search terms.

4. The computer-readable media of claim 1, comprising further computer-executable instructions for requesting explicit user specification of user interests; wherein the computer-executable instructions for generating the user profile comprise computer-executable instructions for generating the user profile utilizing the user-specified user interests.

5. The computer-readable media of claim 1, comprising further computer-executable instructions for requesting user permission to access user social networking profiles; wherein the computer-executable instructions for generating the user profile comprise computer-executable instructions for generating the user profile utilizing user interests identified from accessed user social networking profiles.

6. The computer-readable media of claim 1, wherein the advertising display area is a tile that is pinned to a start screen.

7. The computer-readable media of claim 1, wherein the computer-executable instructions for transmitting the termination notification comprise computer-executable instructions for transmitting periodic notifications indicating that the received advertisements are still being presented in the advertising display area; wherein the termination notification in an implicit termination notification comprising a ceasing of the transmission of the periodic notifications.

8. The computer-readable media of claim 1, comprising further computer-executable instructions for enticing a user by offering the user credits in exchange for the generating the display of the received advertisements in the advertising display area.

9. The computer-readable media of claim 1, wherein the computer-executable instructions for generating the user profile utilizing the user-generated data comprise computer-executable instructions for weighting recent user-generated data more heavily in generating the user profile.

10. The computer-readable media of claim 1, comprising further computer-executable instructions for receiving an updated audience taxonomy, comprising additional audiences; and repeating the categorizing the user into the one or more audiences based on the updated audience taxonomy.

11. One or more computer-readable media comprising computer-executable instructions for presenting advertisements to users for an extended period of time, the computer-executable instructions performing steps comprising:
receiving bids from advertisers directed to a specified exposure time to a specified audience;
selecting at least one advertisement to display to the specified audience based on the received bids;
identifying users categorized into the specified audience;
transmitting the selected at least one advertisement to the identified users; and
providing credit to the identified users for being exposed to the selected at least one advertisement.

12. The computer-readable media of claim 11, wherein the specified audience is limited by a geographic region.

13. The computer-readable media of claim 11, comprising further computer-executable instructions for receiving an identification of one or more audiences into which a user was categorized; and adding the user to the identified one or more audiences.

14. The computer-readable media of claim 11, comprising further computer-executable instructions for receiving a termination notification indicating that advertisements will no longer be presented to a user; and removing the user from one or more audiences into which the user was categorized.

15. The computer-readable media of claim 11, wherein the computer-executable instructions for providing the credit to the identified users comprises providing an amount of credit to the identified users based on bids associated with the selected at least one advertisement.

16. A system of presenting advertisements to users for an extended period of time, the system comprising:
an advertising computing device comprising an audience taxonomy, advertiser bids, user credits and a first computer-readable medium comprising computer-executable instructions for performing steps comprising: receiving the advertiser bids from advertisers, the advertiser bids being directed to a specified exposure time to a specified audience; selecting at least one advertisement to display to the specified audience based on the received bids; identifying users categorized into the specified audience; transmitting the selected at least one advertisement to the identified users; and providing, by incrementing appropriate ones of the user credits, credit to the identified users for being exposed to the selected at least one advertisement; and
a second computer-readable medium comprising computer-executable instructions for execution on a client computing device separate from the advertising computing device, the computer-executable instructions performing steps comprising: requesting user permission to access user-generated data indicative of user interests; generating a user profile utilizing the user-generated data; categorizing, based on the generated user profile, a user into one or more audiences selected from a received audience taxonomy; transmitting, to the advertising computing device, an identification of the one or more audiences into which the user was categorized; receiving, from the advertising computing device the at least one advertisement; generating, on a display device of the client computing device, a display of the received advertisements in an advertising display area that is repeatedly exposed to the user while the user utilizes the client computing device; and transmitting a termination notification indicating that the received at least one advertisement is no longer being presented in the advertising display area.

17. The system of claim 16, wherein the specified audience is limited by a geographic region.

18. The system of claim 16, wherein the user-generated data is user-entered search terms.

19. The system of claim 16, wherein the advertising display area is a tile that is pinned to a start screen.

20. The system of claim 16, wherein the computer-executable instructions for generating the user profile utilizing the user-generated data comprise computer-executable instructions for weighting recent user-generated data more heavily in generating the user profile.
